(19) United States
(12) Patent Application Publication
(10) Pub. No.: US 2009/0271573 A1
(43) Pub. Date: Oct. 29, 2009

(54) PARTITIONED MANAGEMENT DATA CACHE

(76) Inventor: Shivkumar Kannan, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/144,972

(22) Filed: Jun. 24, 2008

(30) Foreign Application Priority Data
Apr. 28, 2008 (IN) 1043/CHE/2008

(51) Int. Cl. G06F 12/08

(52) U.S. Cl. 711/129; 711/133; 711/E12.022; 711/E12.023

(57) ABSTRACT

A system and method for decreasing system management data access time. A system includes a device, a cache memory coupled to the device, and a cache memory refresh controller. The device provides system management information. The cache memory stores system management information. The system management information stored in the cache is partitioned into a first portion and a second portion. The cache refresh program refreshes the system management information stored in the cache memory. The first portion is refreshed after expiration of a predetermined refresh time interval. The second portion is refreshed when the second portion is accessed.

### BACKGROUND

Business entities and other enterprises employing computer networks need to monitor and control the various elements connected to their networks to optimize performance and ensure efficient utilization of resources. The Distributed Management Task Force (“DMTF”) is a computer industry organization promoting development of standards and technology applicable to management of distributed computer systems.

Web-Based Enterprise Management (“WBEM”) is a DMTF standard developed as a non-proprietary means of accessing and modifying management information in an enterprise network. WBEM provides means to collect system management information in enterprise networks comprising hardware from multiple vendors, and employing a variety of protocols, operating systems and applications.

The Common Information Model (“CIM”), a central component of the WBEM specification, provides a standardized method for describing the data transferred through WBEM. CIM is an extensible specification for defining management data provided by the various components distributed across a networked system. The CIM specification defines the modeling, naming, and mapping methods used to represent and exchange management information between system elements.

The quantity of management data retrieved by management applications through WBEM providers is continually increasing. New consumers of management information add to the load on providers, which offer access to system element management information. Additionally, the variety of protocols implemented to retrieve device data tends to increase provider response time. While increases in system management information request response times have minimal effect on some applications, increasing response delays are detrimental to those applications for which real-time access to management information is desirable.

### BRIEF DESCRIPTION OF THE DRAWINGS

For a detailed description of exemplary embodiments of the invention, reference will now be made to the accompanying drawings in which:

FIG. 1 shows a block diagram of a distributed computer system in accordance with various embodiments;

FIG. 2 shows a block diagram of a management information cache comprising on-demand and periodic refresh in accordance with various embodiments;

FIG. 3 shows a block diagram of a distributed computer system comprising a provider with management information caching in accordance with various embodiments;

FIG. 4 shows a block diagram of a distributed computer system comprising a CIM server with management information caching in accordance with various embodiments; and

FIG. 5 shows a flow diagram for a method of refreshing a management information cache comprising on-demand and periodic refresh in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a collection of two or more hardware and/or software components, and may be used to refer to an electronic device or devices, or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Businesses and other users of distributed computer systems apply standardized system management information methods, such as those specified by the Web-Based Enterprise Management (“WBEM”) framework of the Distributed Management Task Force (“DMTF”), to manage their enterprise computing environments. WBEM simplifies management of such systems by providing a consistent interface to management applications across the various systems, applications, networks, and devices to be managed.

A variety of factors influence management information response time in a WBEM system. System entities known as “providers” return information about and set parameters in a managed object (e.g., a device). Providers are generally implemented as software executables. Providers are often implemented as proxies, that is, the provider is remote from the device to which the provider offers access. Such providers apply a variety of protocols, to retrieve data from a device, and these protocols add to response overhead. Additionally, a single provider may support multiple devices, thereby increasing the number of queries from management applications the provider must handle, resulting in response delays. Further, if a device is heavily loaded performing compute or input/output operations, the device's response to a provider's queries may be delayed.

Embodiments of the present disclosure implement a system management data cache to decrease response time to management data requests. Caching tends to increase request throughput because the majority of the management data requests received are read requests, while configuration change requests are relatively rare. One embodiment of a system management data cache relies on the managed devices to provide notice to the cache when the device's management data changes so that the cache can be timely updated. Many devices provide no such notice mechanism however, while other devices provide notice as to changes in some management data elements but not as to others. In another embodiment, the cache retrieves data from the devices and updates the cached values on a periodic basis. Embodiments of the present disclosure apply a combination of cache refresh methodologies to optimize throughput. More specifically, system management information to be cached, for example Common Information Model (“CIM”) classes as specified in WBEM, are partitioned into two sets. The members of the first set are refreshed “on-demand,” that is whenever a request for return of that class is received by the cache. Members of the second set, information not selected for on-demand refresh, is refreshed at a pre-selected time interval.

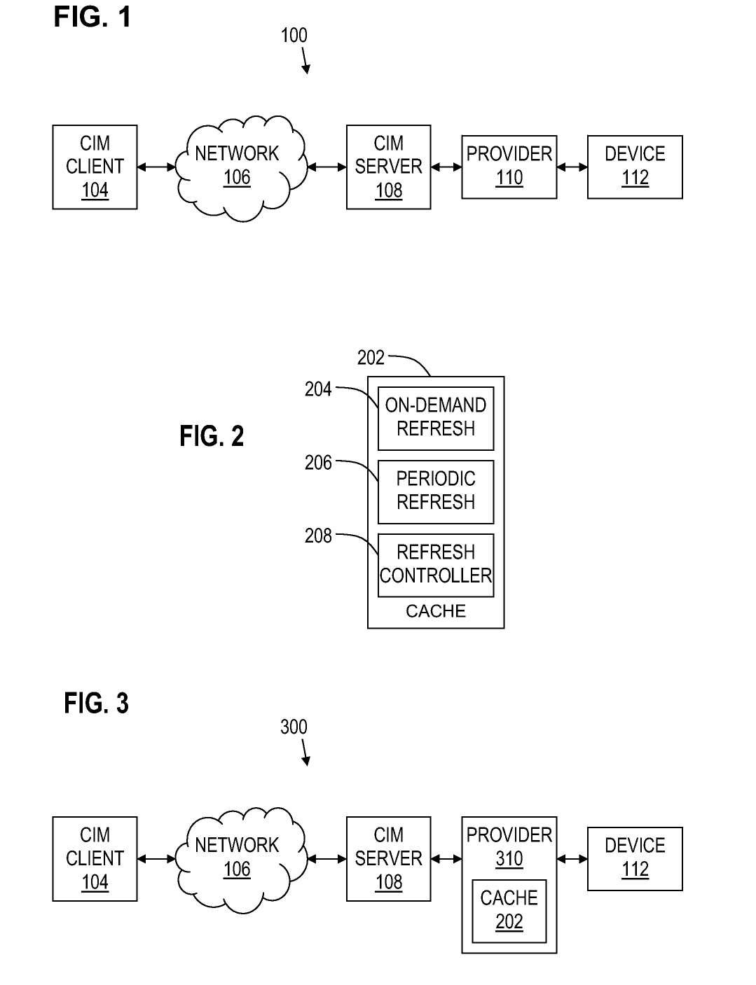

FIG. 1 shows a block diagram of a distributed computer system 100 in accordance with various embodiments. A CIM Client 104 issues requests for the return of system management information or for configuration changes to a device, system, application, or other manageable component. For simplicity, only a single CIM Client 104 is illustrated. However, an operational distributed computer system may contain any number of CIM Clients issuing requests. The CIM Client 104 is generally implemented as a software program running on a computing device, for example a personal computer, a workstation, a server, an embedded computer, or any other computing device adapted to serve as a CIM Client.

System management information requests issued by CIM Client 104 may traverse the network 106 in route to CIM Server 108. The network 106 may comprise any computer networking technology, for example, a local area network (“LAN”), a storage array network (“SAN”), a wide area network (“WAN”), an metropolitan area network (“MAN”), the internet, etc. Communications exchanged between CIM Client 104 and CIM Server 106 may be based on any mechanisms and protocols adapted to communication system management information requests and responses, for example, transmission control protocol (“TCP”), internet protocol (“IP”), hypertext transport protocol (“HTTP”), and/or CIM Operations over HTTP with CIM mapping to XML (“CIM-XML”).

The CIM Server 108 receives, via the network 106, requests from CIM Client 104 for information regarding device 112. The CIM Server 108 processes these requests and interfaces with a provider 110 to acquire the requested information. For simplicity, only a single provider 110 is illustrated. In practice, however, system 100 may include any number of providers. The provider 110, generally, supplies information about a specific type of device 112, for example a specific model of disk storage array from a particular manufacturer. The provider 110 translates the information request as required for communication with the device 112, and obtains the requested information from the device 112, or informs the device 112 of configuration operations to be performed. The provider 110 translates information retrieved from the device 112 in accordance with the form expected by CIM Server 108 (e.g., a CIM class), and returns the requested information to the CIM Server 108. The CIM Server 108, in turn, transmits the information to the requesting CIM Client 104. The CIM Server 108 and the provider 110 are generally implemented as software programs executed by a processor or other computing device.

The device 112 may comprise a hardware device, for example, a disk array, a printer, a server, or any other hardware device adapted to the provide system management information. The device 112 may also comprise a software application running on a computer, for example, an operating system, a database program, or any other software program adapted to provide system management information. While only a single device 112 is illustrated, in practice system 100 may include one or more such devices.

The components of system 100 may be implemented on a single computing device or on any number of different computing devices including, for example, a personal computer, a workstation, a server, an embedded computer, or any other computing device. Additionally, any of the components of system 100 may be interconnected through network 106 or any other networking or component interconnection means.

As described, the provider 110 may retrieve management information from device 112 in response to a request from CIM Client 104. Rather than encumbering the provider 110 with the burden of requesting information from device 112 each time CIM Client 104 requests such information, however, system 100 preferably includes a system management data cache to improve management data response time. The system management data cache stores system management information for return to the requesting CIM Client 104 without needlessly retrieving the information from the device 112 on each request. The system management data cache preferably includes both on-demand and periodic refreshing of selected data elements stored in the cache.

FIG. 2 shows a block diagram of a management information cache 202 comprising on-demand refresh 204 and periodic refresh 206 in accordance with various embodiments. Each of the various management information elements (e.g., CIM classes) of device 112 to be cached are categorized for inclusion in either a set of elements that will be refreshed on demand 204, or a set of elements that will be refreshed periodically 206 (i.e., on expiration of a selected time interval). The information may be categorized, for example, by selecting those elements best suited to on-demand refresh and placing all other elements in the periodic refresh set. In some embodiments, those classes containing data most likely to change may be suitable for membership in the on-demand set. Embodiments may seek to minimize the number of elements included in the on-demand set because these elements are refreshed each time they are requested.

The memories used by cache 202 for storage of information refreshed on-demand or periodically may be any memories suited for quick retrieval of stored data, including any variety of read/write random access memory (“RAM”), for example, dynamic RAM (“DRAM”), static RAM (“SRAM”), magnetic RAM (“MRAM”), NanoRAM (“NRAM”), Ferro-electric RAM (“FeRAM”) or equivalents.

On-demand refresh causes a cache refresh to execute whenever a member of the on-demand refresh set 204 is requested. Thus, if CIM Client 104 requests the return of management data included in the on-demand refresh set 204, the cache refresh controller 208 identifies the request as pertaining to the on-demand set 204, and initiates a refresh of the requested data with fresh data from device 112. The requested data is read from the cache and returned to CIM Client 104. As described, some embodiments refresh only the requested data (e.g., the requested class). Other embodiments refresh the requested data and any data related to the requested data (e.g., the requested class and associated classes).

If the CIM Client requests the return of system management data included in the periodic refresh set, as above, cache refresh controller 208 first determines the set to which the requested data belongs. If the requested data is not a member of the on-demand refresh set, the requested data belongs to the periodic refresh set. In some embodiments, on reception of a request for data from the periodic refresh set, if a selected time duration (i.e., the periodic refresh interval) has elapsed since the last refresh of the set, refresh controller 208 will initiate a refresh of at least the requested set members by retrieving fresh data from device 112. In other embodiments, refresh controller 208 may initiate refresh of set elements when the refresh interval expires without receiving an access request. In any case, embodiments read the requested data from the cache and return the cached data to the CIM Client 104.

Irrespective of whether a class is included in the on-demand refresh set or the periodic refresh set, a write request (e.g., a configuration change request) from the CIM Client 104 affecting that class will cause the class to be updated accordingly. Cache refresh controller 208 recognizes the management information related to a write request and after the write is complete, the cache refresh controller 208 obtains updated information from the device 112 to refresh the cache. The refresh controller 208 may be implemented as a software program executing on one or more processors.

Embodiments of the present disclosure may implement system management information cache 202 as a sub-system of various system components. FIG. 3 shows a block diagram of a distributed computer system 300 comprising a provider 310 that includes a management information cache 202 in accordance with various embodiments. In this embodiment, the cache refresh actions described above are performed in the provider 310. The provider determines the device specific classes corresponding to set elements being refreshed and requests those elements from the device 112. Advantageously, for embodiments of system 300 to benefit from management data caching, the CIM Server 108 need have no knowledge of the caching included in the provider 310. Thus, system performance enhancements enabled by caching are obtainable by acquiring a caching provider for a device.

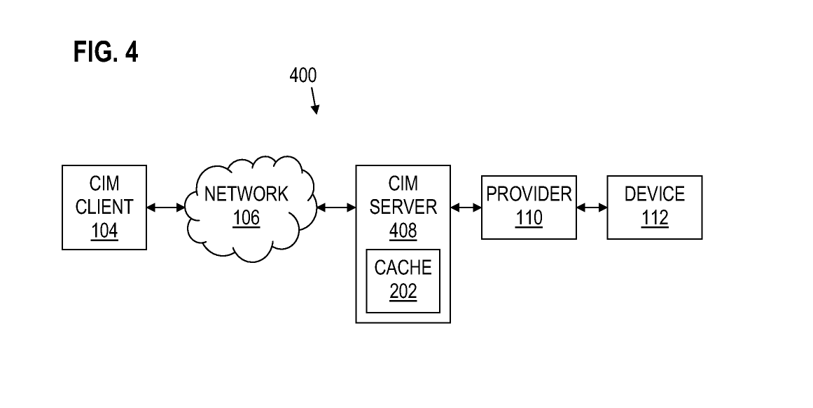

FIG. 4 shows a block diagram of a distributed computer system 400 comprising a CIM server 408 including a management information cache 202 in accordance with various embodiments. In this embodiment, the CIM Server 408 determines the classes to be refreshed and sends a request for the required information to provider 110. Provider 110 retrieves the requested information from device 112, and returns the information to the CIM Server 408. The fresh information is written to cache 202. In this embodiment, the cache 202 is not device specific and allows for caching of management data supplied by multiple providers.

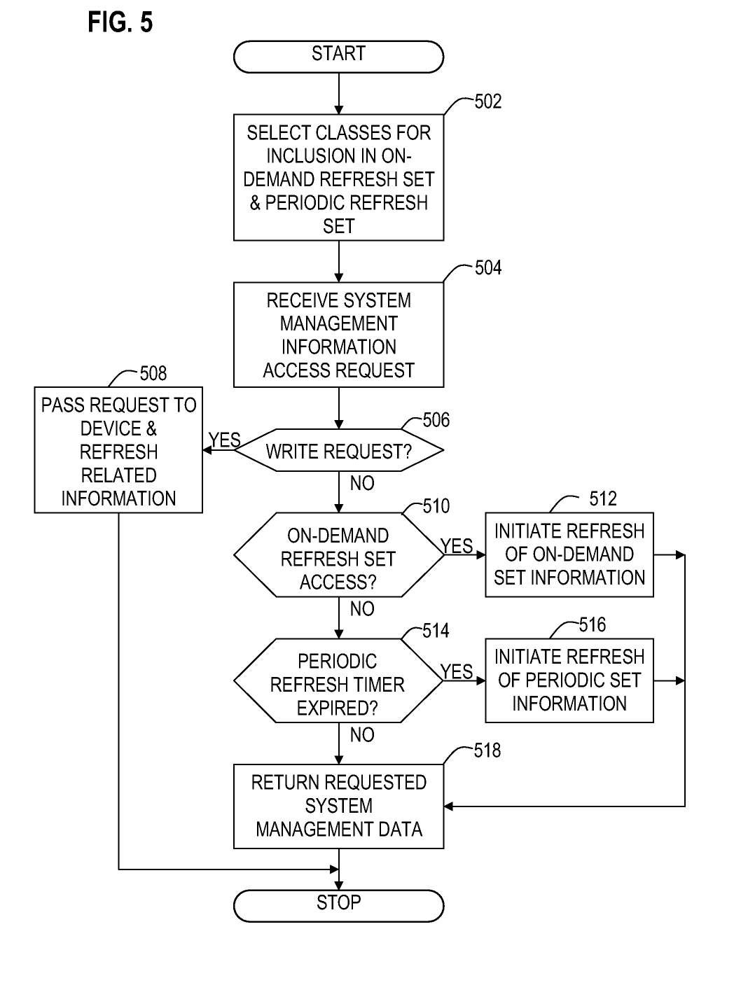

FIG. 5 shows a flow diagram for a method of refreshing a management information cache comprising on-demand and periodic refresh in accordance with various embodiments. Though depicted sequentially as a matter of convenience, at least some of the actions shown can be performed in a different order and/or performed in parallel. In block 502, CIM classes (i.e., system management data) are selected for inclusion in a set of CIM classes that will be refreshed on-demand. Generally, the classes selected may be those that would be least effectively served by periodic refresh. For example, those classes corresponding to management information most likely to change without notice to the cache may be good candidates for inclusion in the on-demand refresh set. In some embodiments, classes corresponding to system information likely to change more frequently than the time interval assigned to periodic refresh may be good candidates for inclusion in the on-demand refresh set. Embodiments may seek to minimize the number of classes included in the on-demand set in order to reduce the number of information update requests served on the device 112. Classes not selected for inclusion in the on-demand refresh set may be included in the periodic refresh set. Refresh set selections may be made by one having expert knowledge concerning the particular system information domain at issue. For example, when storage device management information is at issue, an expert in storage device and storage system operation may be able to most effectively determine which device information should be included in the on-demand set and which device information should be included in the periodic refresh set.

In block 504, management information classes have been partitioned into on-demand and periodic refresh sets, and a system comprising an embodiment of the management information cache disclosed herein is running, and receives a system management information access request. If, in block 506, the request is determined to be a write request, then the request is passed to the device 112, cache information related to the write is retrieved from the device 112 after completion of the write operation, and the related information in cache 202 is refreshed in block 508.

If, in block 506, the request is determined to be a read, then the request is parsed, in block 510, to determine whether the information requested belongs to a class assigned to the on-demand refresh set. If the requested access is of a class assigned to the on-demand refresh set, then a refresh of the on demand set management information is initiated in block 512, and after the fresh data is received and the cache 202 is updated, the requested data is returned to the requesting client 104 in block 518.

On the other hand, if the requested access is not of a class assigned to the on-demand refresh set, indicating that the requested class is assigned to the periodic refresh set, then some embodiments may check, in block 514, for expiration of the periodic refresh timer. Such embodiments initiate a refresh of system management information in the periodic refresh set, in block 516, when an access to the set is received and the timer has expired. If a refresh is initiated, in block 516, then after fresh data is received and the cache 202 is updated, the requested data is read from cache 202 and returned to the requesting client 104 in block 518. If no refresh is required, the requested data is read from the cache and returned to the client 104 in block 518. Some embodiments refresh the periodic refresh set based on other conditions, for example, the expiration of the refresh timer alone.

The above discussion is meant to be illustrative of the principles and various embodiments of the present invention. Numerous variations and modifications will become apparent to those skilled in the art once the above disclosure is fully appreciated. For example, while the exemplary embodiments have been described in view of the Web-Based Enterprise Management framework, those skilled in the art will recognize that embodiments are not so limited, but rather are applicable to any system management information retrieval system. It is intended that the following claims be interpreted to embrace all such variations and modifications.

What is claimed is:

1. A system, comprising:
a device that provides system management information;
a cache memory, that stores system management information, coupled to the device, the system management information is partitioned into a first portion and a second portion; and
a cache memory refresh controller that updates the system management information stored in the cache memory;
wherein the cache refresh controller refreshes the first portion after expiration of a pre-determined refresh time interval, and refreshes the second portion when the second portion is accessed.

2. The system of claim 1, wherein the second portion comprises system management information selected based on the likelihood that the information will change more frequently than the period of the pre-determined refresh time interval.

3. The system of claim 1, wherein the cache refresh controller causes system management information stored in the cache memory to be refreshed when system management information is written to a device.

4. The system of claim 1, wherein the system management information stored in the cache memory comprises Common Information Model (“CIM”) classes.

5. The system of claim 1, further comprising a provider coupled to the device, the Provider comprising the cache memory and the cache refresh controller.

6. The system of claim 1, further comprising a server coupled to a provider, the Server comprising the cache memory and the cache refresh controller.

7. The system of claim 1, wherein the first portion is refreshed when data in the first portion is requested after the pre-determined refresh time interval has elapsed.

8. The system of claim 1, wherein the cache refresh controller determines whether a system management information request is requesting information assigned to the first partition or information assigned to the second partition.

9. The system of claim 1, wherein the system is a distributed computer system.

10. A method, comprising:
partitioning system management information into a first set and a second set;
storing the first set and the second set in a cache memory;
refreshing the first set in cache memory after expiration of a pre-determined refresh time interval; and
refreshing the second set in cache memory when the second set is accessed.

11. The method of claim 10, further comprising selecting the management information included in the second set based on the likelihood that the information will change more frequently than the period of the pre-determined time interval.

12. The method of claim 10, further comprising refreshing system management information in the cache memory when system management information is written to a device that provides cacheable data.

13. The method of claim 10, further comprising storing a CIM class in the cache memory.

14. The method of claim 10, further comprising determining whether requested system management information is a member of the first set or the second set.

15. The method of claim 10, further comprising performing the cache storage and refresh operations in a provider coupled to a device from which the provider obtains system management information.

16. The method of claim 10, further comprising performing the cache storage and refresh operations in a server coupled to a provider.

17. The method of claim 10, further comprising refreshing the first set in cache memory when the first set is accessed after the pre-determined time interval has elapsed.

18. A computer program product, comprising:
a computer useable medium having computer readable program code embodied therein, the computer readable program code comprising:
instructions that access a first set and a second set of system management information in cache memory;
instructions that refresh the first set in cache memory after expiration of a pre-determined refresh time interval; and
instructions that refresh the second set in cache memory when the second set is accessed.

19. The computer program product of claim 18, further comprising instructions implementing a provider that interfaces to a device, the provider instructions comprising:
instructions that determine whether a system information access is accessing information contained in the first set or information contained in the second set;
the instructions that access the first set and second set of system management information in cache memory;
the instructions that refresh the first set after expiration of a pre-determined refresh time interval; and
the instructions that refresh the second set when the second set is accessed.

20. The distributed computer system of claim 18, further comprising instructions implementing a server that interfaces to a provider, the server instructions comprising:
instructions that determine whether a system information access is accessing information contained in the first set or information contained in the second set;
the instructions that access the first set and second set of system management information in cache memory;
the instructions that refresh the first set after expiration of a pre-determined refresh time interval; and
the instructions that refresh the second set when the second set is accessed.
